(19) United States
(12) Patent Application Publication
(10) Pub. No.: US 2015/0217344 A1
(43) Pub. Date: Aug. 6, 2015

(54) DRUM WASHING APPARATUS

(71) Applicant: KAYABA INDUSTRY CO., LTD., Tokyo (JP)

(72) Inventor: Kazunori Tanaka, Saitama (JP)

(73) Assignee: KAYABA INDUSTRY CO., LTD., Tokyo (JP)

(21) Appl. No.: 14/421,449

(22) PCT Filed: Mar. 19, 2014
(86) PCT No.: PCT/JP2014/057534

§ 371 Date: Feb. 13, 2015

(30) Foreign Application Priority Data
Mar. 22, 2013 (JP) 2013-059802

(51) Int. Cl. B08B 9/08; B60P 3/16

(52) U.S. Cl. CPC B08B 9/0813; B60P 3/16

(57) ABSTRACT

A drum washing apparatus for washing an interior of a mixer drum carried on a mixer truck includes a washing liquid supply hose for supplying a washing liquid; a washing pipe connected to the washing liquid supply hose, a tip end portion of which is inserted into the interior of the mixer drum through an open end of the mixer drum; and an ejection portion provided in the washing pipe to eject the washing liquid into the mixer drum. The washing pipe is adapted to be capable of moving in response to an externally applied external force.

### TECHNICAL FIELD

The present invention relates to a drum washing apparatus for washing an interior of a mixer drum carried on a mixer truck.

### BACKGROUND ART

A mixer truck carries fresh concrete in a mixer drum that is carried on a vehicle body to be free to rotate, and transports the fresh concrete.

Japanese Utility Model Application Publication H04-36886 discloses a drum washing apparatus for a mixer truck that washes the interior of a mixer drum by ejecting washing water from a washing pipe attached to a fresh concrete supply hopper.

### SUMMARY OF INVENTION

In a mixer truck, after all of the fresh concrete carried in the mixer drum has been discharged, a washing operation is performed to wash away fresh concrete adhered to a drum inner wall surface and a drum blade using washing water ejected from a washing pipe so that the fresh concrete adhered to the mixer drum does not remain and harden.

During the washing operation, an operator may clean a periphery of a rear portion open end of the mixer drum using a brush or the like. When the brush or the like used at this time collides with the washing pipe of the drum washing apparatus, the metal washing pipe may deform or bend back. When the washing pipe is damaged in this manner, a washing effect of the drum washing apparatus may deteriorate.

An object of the present invention is to provide a drum washing apparatus for a mixer truck with which damage to a washing pipe can be prevented.

According to an aspect of the present invention, a drum washing apparatus for washing an interior of a mixer drum carried on a mixer truck includes a washing liquid supply hose for supplying a washing liquid; a washing pipe connected to the washing liquid supply hose, a tip end portion of which is inserted into the interior of the mixer drum through an open end of the mixer drum; and an ejection portion provided in the washing pipe to eject the washing liquid into the mixer drum. The washing pipe is adapted to be capable of moving in response to an externally applied external force.

### BRIEF DESCRIPTION OF DRAWINGS

FIG. 1 is a side view of a mixer truck including a drum washing apparatus according to a first embodiment of the present invention.

FIG. 2 is an enlarged perspective view showing a rear portion of the mixer truck.

FIG. 3 is a schematic view showing a configuration of the drum washing apparatus according to the first embodiment.

FIG. 4A is a schematic view showing a configuration of a drum washing apparatus according to a second embodiment of the present invention.

FIG. 4B is a partial longitudinal sectional view of the drum washing apparatus according to the second embodiment.

### DESCRIPTION OF EMBODIMENTS

### First Embodiment

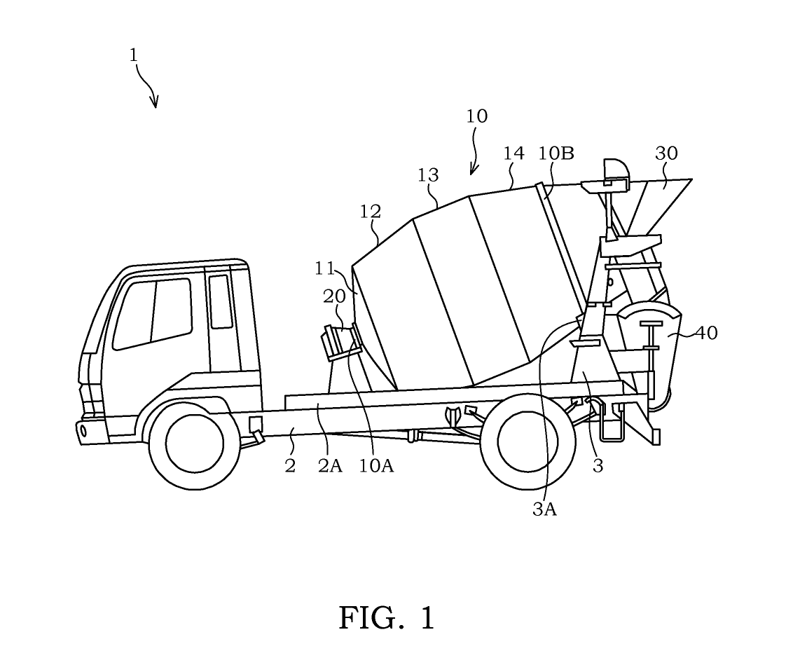

A first embodiment of the present invention will be described below with reference to FIGS. 1 to 3.

A mixer truck 1 shown in FIG. 1 is a vehicle that transports fresh concrete introduced into a mixer drum 10 at a concrete plant.

As shown in FIG. 1, the mixer truck 1 includes the mixer drum 10 for carrying the fresh concrete, a driving apparatus 20 adapted to drive the mixer drum 10 to rotate, a hopper 30 adapted to supply the fresh concrete to the mixer drum 10, and a chute 40 adapted to guide fresh concrete discharged from the mixer drum 10 to a predetermined position.

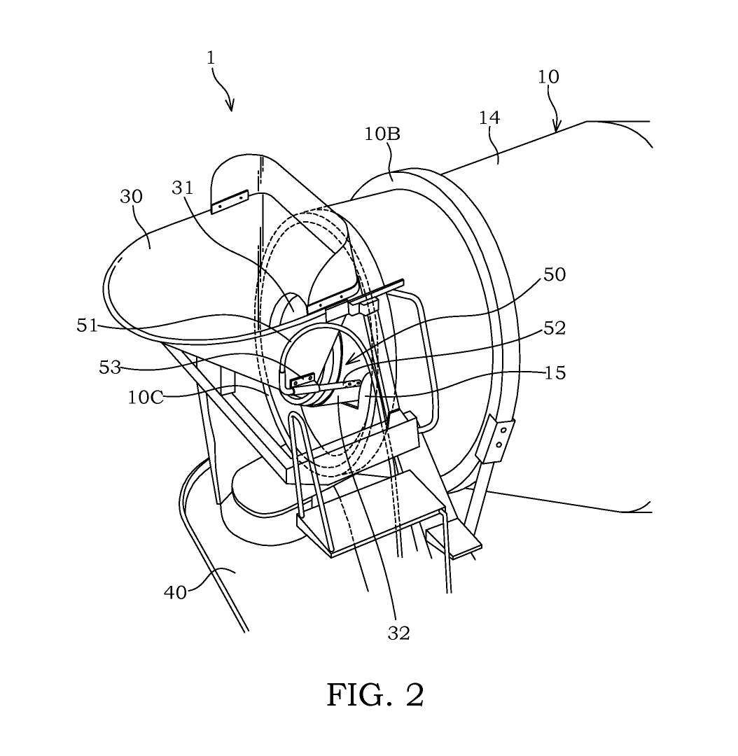

As shown in FIGS. 1 and 2, the mixer drum 10 is a tubular member formed with an open end 10C (see FIG. 2) on a rear end thereof, which is carried on a frame 2A of a vehicle body 2 to be free to rotate. The mixer drum 10 includes an end plate 11 constituting a front side closed end, a front shell 12 connected to a rear end of the end plate 11, a center shell 13 connected to a rear end of the front shell 12, and a rear shell 14 connected to a rear end of the center shell 13. A rear end of the rear shell 14 constitutes the open end 10C of the mixer drum 10.

As shown in FIG. 1, a drive shaft 10A is provided centrally on a front surface of the end plate 11 of the mixer drum 10, and a roller ring 10B is provided on a rear portion outer periphery of the rear shell 14 of the mixer drum 10. The drive shaft 10A of the mixer drum 10 is coupled to a hydraulic motor (not shown) of the driving apparatus 20, which is disposed on a front portion of the frame 2A. The roller ring 10B of the mixer drum 10 is supported from below by a plurality of rollers 3A of a support portion 3 disposed on a rear portion of the frame 2A. The mixer drum 10 is disposed on the frame 2A in a frontward tilting attitude such that a drum rear portion is raised upward. The mixer drum 10 is configured to be rotated either normally or in reverse by the hydraulic motor of the driving apparatus 20.

As shown in FIG. 2, a drum blade 15 is disposed in the mixer drum 10 in a spiral shape that follows a drum inner wall surface. The drum blade 15 rotates together with the mixer drum 10, whereby fresh concrete carried in the mixer drum 10 is agitated and so on.

When the mixer drum 10 rotates normally, the drum blade 15 moves the fresh concrete in the mixer drum 10 forward while agitating the fresh concrete. When the mixer drum 10 rotates in reverse, on the other hand, the drum blade 15 moves the fresh concrete rearward while agitating the fresh concrete. By rotating the mixer drum 10 in reverse, the fresh concrete can be discharged through the open end 10C of the mixer drum 10. The fresh concrete discharged from the mixer drum 10 is guided to a predetermined position through the chute 40, which is provided in a rear lower portion of the mixer truck 1 to be free to revolve.

When fresh concrete is introduced into the mixer drum 10 through the hopper 30, which is provided in a rear upper portion of the mixer truck 1, the mixer drum 10 is rotated normally at a higher speed than an agitation rotation speed. The fresh concrete supplied to the hopper 30 is introduced into the mixer drum 10 through a seal pipe 32 that communicates with a discharge port 31 of the hopper 30.

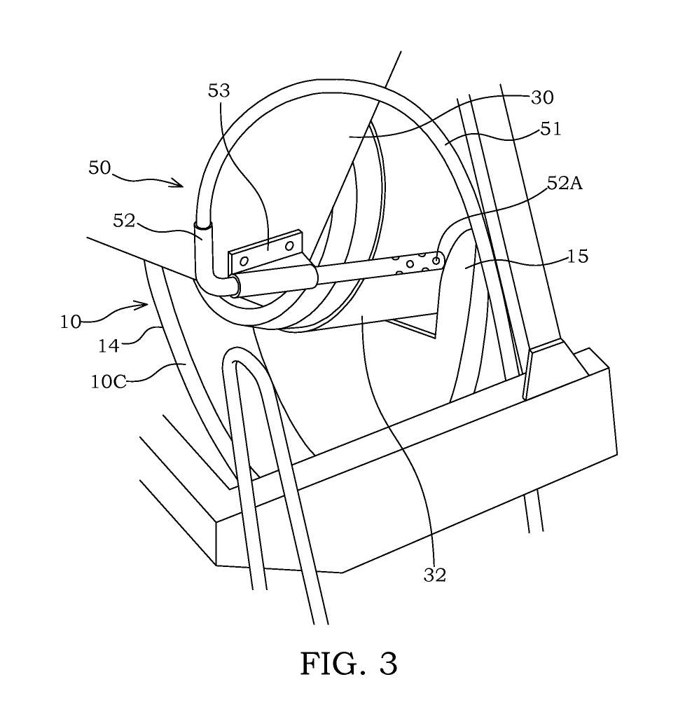

Next, referring to FIGS. 2 and 3, a drum washing apparatus 50 provided in the mixer truck 1 will be described. The drum washing apparatus 50 washes an interior of the mixer drum 10 using washing water (washing liquid).

As shown in FIGS. 2 and 3, the drum washing apparatus 50 includes a washing water supplying hose 51, a washing pipe 52 connected to the hose 51, and a holder 53 that fixes the washing pipe 52 to the hopper 30.

The hose 51 is a rubber hose, for example, that supplies washing water to the washing pipe 52. One end of the hose 51 is connected to a discharge portion of a high pressure pump, not shown in the figures, for pumping the washing water, and another end of the hose 51 is connected to the washing pipe 52. The washing water is stored in a water tank (not shown) disposed on the front portion of the frame 2A, and the high pressure pump is disposed adjacent to the water tank.

The washing pipe 52 is fixed to a lower portion of an outer side face of the hopper 30 via the holder 53, which is disposed in a position close to a base end portion of the washing pipe 52. In this embodiment, the washing pipe 52 is fixed to a side portion of the hopper 30 using the holder 53, but the washing pipe 52 may be fixed directly to the hopper 30 without using the holder 53. Further, the washing pipe 52 is formed as a substantially L-shaped tubular member, but may be formed as a rectilinear tubular member. Hence, the washing pipe 52 is formed in a desired shape according to requirements.

The base end portion of the washing pipe 52 is connected to the hose 51. A tip end portion of the washing pipe 52 is formed as a closed end. The tip end portion of the washing pipe 52 is inserted into the mixer drum 10 through the open end 10C of the mixer drum 10. The washing pipe 52 is disposed such that the tip end portion thereof does not interfere with the drum inner wall surface and the drum blade 15.

A plurality of ejection holes 52A connecting the inside of the washing pipe 52 to the outside are formed in an outer peripheral surface of the tip end portion of the washing pipe 52. The ejection holes 52A are disposed in mutually deviating positions in both a pipe axis direction and a pipe circumference direction.

In the mixer truck 1, after all of the fresh concrete carried in the mixer drum 10 has been discharged, a washing operation by the drum washing apparatus 50 is started. When the washing operation is started, the high pressure pump, which is disposed parallel to the water tank, is driven such that washing water discharged from the high pressure pump is supplied to the washing pipe 52 through the hose 51. The washing water supplied to the washing pipe 52 is ejected into the mixer drum 10 through the ejection holes 52A in order to wash away fresh concrete adhered to the drum inner wall surface and the drum blade 15.

In the drum washing apparatus 50 according to this embodiment, the washing pipe 52 is configured to be capable of moving in response to an externally applied external force. In other words, the washing pipe 52 is formed from an elastic body made of rubber, plastic, or the like such that the pipe itself is capable of elastic deformation.

During the washing operation, an operator may clean a periphery of the open end 10C of the mixer drum 10 using a brush or the like. When the brush used to clean the open end 10C collides with the washing pipe 52, the washing pipe 52 deforms elastically in accordance with a collision force of the brush. However, when the external force, such as the collision force of the brush, is released, the washing pipe 52 returns to its original shape.

With the drum washing apparatus 50 for the mixer truck 1 according to the first embodiment, described above, following effects are obtained.

The drum washing apparatus 50 includes the washing pipe 52 having the ejection holes 52A for ejecting the washing water, and the washing pipe 52 is configured to be capable of moving in response to an externally applied external force. In other words, the washing pipe 52 is formed from an elastic body such that the pipe itself is capable of elastic deformation.

Hence, when an external force acts on the washing pipe 52, the washing pipe 52 deforms elastically in accordance with the external force, and therefore the washing pipe 52 does not remain deformed so as not to return to its original shape. As a result, damage to the washing pipe 52 can be prevented, and deterioration of a washing effect caused by damage to the washing pipe 52 can be suppressed. Moreover, a brush or the like does not become sandwiched between the washing pipe 52 and the drum blade 15, and therefore damage to both the washing pipe 52 and the drum blade 15 can be prevented.

### Second Embodiment

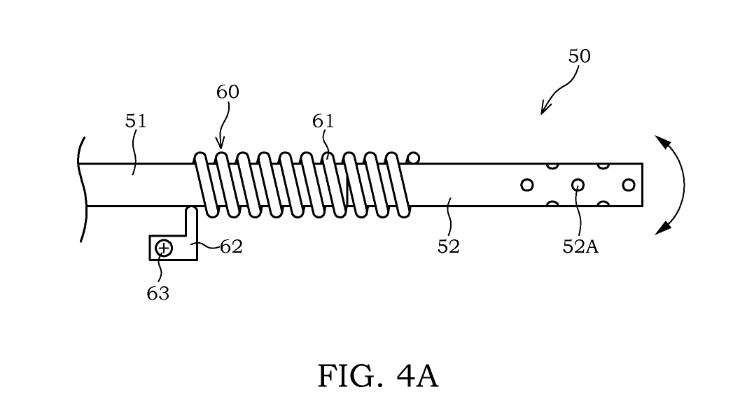

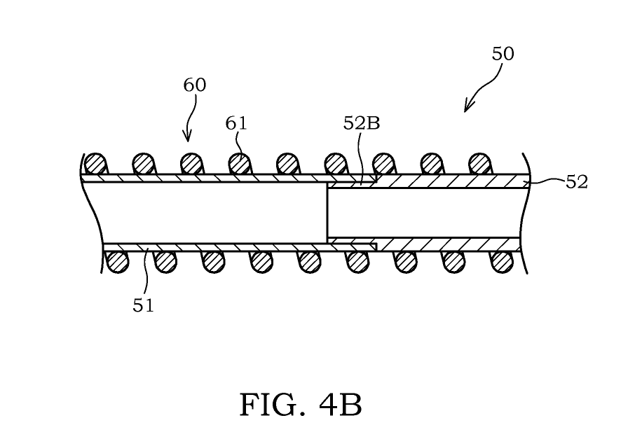

Next, referring to FIGS. 4A and 4B, a second embodiment of the present invention will be described. Description of the second embodiment will focus on differences with the first embodiment. It should be noted that in FIGS. 4A and 4B, identical constituent parts to the first embodiment have been allocated identical reference symbols to the first embodiment.

As shown in FIG. 4A, in the drum washing apparatus 50 according to the second embodiment, the washing pipe 52 is a rectilinear tubular member that is fixed to the hopper 30 by a holder 60 instead of the holder 53.

As shown in FIGS. 4A and 4B, a small diameter portion 52B is formed on the base end portion of the washing pipe 52 and set such that an outer diameter thereof is smaller than an outer diameter of the tip end portion. By press-fitting the small diameter portion 52B into an end portion inner peripheral surface of the hose 51, the washing pipe 52 and the hose 51 are connected.

The holder 60 fixes the washing pipe 52 to the hopper 30 (see FIG. 1) so that the washing pipe 52 is capable of moving in response to an externally applied external force. The holder 60 includes a coil spring 61 that holds the washing pipe 52, and a fixing portion 62 that is connected to the coil spring 61 and fixed to the hopper 30.

The coil spring 61 is a coil shaped spring formed by winding a metal or resin wire into a spiral shape. The coil spring 61 is adapted to hold the washing pipe 52 from a pipe outer peripheral surface side in a condition where the washing pipe 52 is inserted in an axial direction. Accordingly, an inner diameter of the coil spring 61 is set to be substantially identical to the outer diameter of the washing pipe 52.

The coil spring 61 is disposed around a connecting part between the washing pipe 52 and the hose 51, and attached to extend over respective connecting ends of the washing pipe 52 and the hose 51.

The fixing portion 62 is formed integrally with a hose 51 side end portion of the coil spring 61, and fixed to the lower portion of the outer side face of the hopper 30 via a screw 63. By fixing the fixing portion 62 in this manner, the washing pipe 52 is disposed such that the tip end portion thereof is inserted into the mixer drum 10 through the open end 10C.

With the drum washing apparatus 50 for the mixer truck 1 according to the second embodiment, following effects are obtained.

The drum washing apparatus 50 includes the washing pipe 52 having the ejection holes 52A for ejecting the washing water, and the washing pipe 52 is adapted to be capable of moving in response to an externally applied external force. In other words, the washing pipe 52 is fixed to the hopper 30 via the holder 60 including the coil spring 61 that holds the washing pipe 52 in an inserted condition, and is adapted to be capable of moving in response to spring deformation of the coil spring 61.

By having the coil spring 61 of the holder 60 hold the washing pipe 52 in this manner, when an external force acts on the washing pipe 52, the coil spring 61 deflects in response to the external force so that the washing pipe 52 moves, and when the external force is released, the washing pipe 52 is returned to its original position by a spring reaction force.

The washing pipe 52 moves in response to spring deformation of the coil spring 61, and therefore the washing pipe 52 does not remain deformed so as not to return to its original position. As a result, similar effects to the first embodiment are obtained, whereby damage to the washing pipe 52 can be prevented.

Further, the coil spring 61 is disposed around the connecting part between the washing pipe 52 and the hose 51, and therefore the washing pipe 52 can be prevented from becoming detached from the hose 51 while moving. Furthermore, the connecting part between the washing pipe 52 and the hose 51 can be protected.

In the drum washing apparatus 50 according to the second embodiment, the washing pipe 52 may be formed from metal, similarly to a conventional washing pipe, or may be formed from an elastic body, similarly to the first embodiment. When the washing pipe 52 of the drum washing apparatus 50 according to the second embodiment is formed from an elastic body, damage to the washing pipe 52 can be prevented more reliably.

Embodiments of the present invention were described above, but the above embodiments are merely examples of applications of the present invention, and the technical scope of the present invention is not limited to the specific configurations of the above embodiments.

In the drum washing apparatus 50 according to the first and second embodiments, the washing pipe 52 is fixed to the hopper 30 via the holder 53, 60, but the washing pipe 52 is not limited to this fixing position. The washing pipe 52 may be configured to be fixed to a structure provided on the mixer truck 1 other than the hopper 30.

Further, in the drum washing apparatus 50 according to the first and second embodiments, the interior of the mixer drum 10 is washed using washing water, but the interior of the mixer drum 10 may be washed using a liquid other than water.

This application claims priority based on Japanese Patent Application No. 2013-59802, filed with the Japan Patent Office on Mar. 22, 2013, the entire contents of which are incorporated into this specification by reference.

1. A drum washing apparatus for washing an interior of a mixer drum carried on a mixer truck, comprising:
a washing liquid supply hose for supplying a washing liquid;
a washing pipe connected to the washing liquid supply hose, a tip end portion of which is inserted into the interior of the mixer drum through an open end of the mixer drum; and
an ejection portion provided in the washing pipe to eject the washing liquid into the mixer drum,
wherein the washing pipe is adapted to be capable of moving in response to an externally applied external force.

2. The drum washing apparatus as defined in claim 1, wherein the washing pipe is formed from an elastic body such that the pipe itself is capable of elastic deformation.

3. The drum washing apparatus as defined in claim 1, further comprising a holder for disposing the washing pipe on a structure provided on the mixer truck,
wherein the holder comprises:
a coil spring for holding the washing pipe from a pipe outer peripheral surface side in a condition where the washing pipe is inserted; and
a fixing portion provided on the coil spring and fixed to the structure, and
the washing pipe is adapted to be capable of moving in response to spring deformation of the coil spring.

4. The drum washing apparatus as defined in claim 3, wherein the coil spring is disposed around a connecting part between the washing liquid supply hose and the washing pipe.
